(19) United States
(12) Patent Application Publication
(10) Pub. No.: US 2005/0105137 A1
(43) Pub. Date: May 19, 2005

(54) Method for implementing error diffusion process with memory management

(76) Inventors: Shyh-Hsing Wang, Hsinchu (TW); Jessen Chen, Hsinchu (TW)

Correspondence Address: BIRCH STEWART KOLASCH & BIRCH, PO BOX 747, FALLS CHURCH, VA, 22040-0747, US

(21) Appl. No.: 10/814,173

(22) Filed: Apr. 1, 2004

(30) Foreign Application Priority Data
Nov. 14, 2003 (TW) 092131915

(51) Int. Cl. G06K 15/00; G06K 9/00

(52) U.S. Cl. 358/3.03; 358/3.06

(57) ABSTRACT

A method for implementing error diffusion process with memory management is disclosed to separate several small blocks in one image that needs to be error diffused. The size of every small block is smaller than the internal static random access memory (SRAM) size. When doing error diffusion on one small block, the pixels located at the edge of the block that cannot be diffused are reserved in the SRAM or the dynamic random access memory (DRAM). When doing error diffusion on the next block, the previous reserved pixels are reused. These steps are repeated to process all the blocks until the whole image is finished with error diffusion. This method can reduce external DRAM access times, use smaller internal SRAM sizes and improve the performance of the image process hardware.

### BACKGROUND OF THE INVENTION

1. Field of Invention

The invention relates to a memory management method for halftone processing of images. In particular, the invention relates to a memory management method that divides an image into several small blocks for error diffusion and the halftone processing module.

1. Related Art

The multi-function peripheral (MFP) is a machine that has the scan, print, copy and fax functions. Its copy function is achieved with the scan input and the print function. The image data it scans belong to the RGB color range, the print output can only process image data in the KCMY color range. Therefore, the image processing chip of the MFP has to have the function of color conversions.

On the other hand, the image data from the scan input is of continuous tone. That is, each pixel in the image is represented by three bytes, one for each of RGB colors. Each color has 256 levels. However, the print output can only process images in the KCMY color range. The machine has to perform the halftone process on the input images before output. Taking the above-mentioned MFP as an example, the image data with 256 color level changes have to be converted into four color levels (KCMY). The most common halftone processing method is the error diffusion method. Its basic idea is the following. When each pixel is converted from the continuous tone to halftone, there will be color errors. Such errors have to be compensated by its surrounding pixels. For example, dark red can only be represented using red. As human eyes are only sensitive to colors covering a large area, one thus has to use darker colors for the surrounding pixels to obtain the desired color.

Generally speaking, the error diffusion method can be implemented using the 3×5 error diffusion filter (proposed by Jarvis, Judice and Ninke) and the 2×3 error diffusion filter (proposed by Floyd and Steinberg). The former diffuses the error to the 12 pixels to the right of and below the pixel being processed (see FIG. 1A). The numbers in the pixels represent their weights. The latter diffuses the error to the four pixels to the right of and below the pixel being processed (see FIG. 1B). Such errors are accumulative. That is, the pixels that receive errors will diffuse the errors to their right and downward. The processed pixels have to be stored in memory for the next error diffusion. Taking the 3×5 error diffusion filter as an example, its takes two rows of processed pixels and adds to them one row of original pixel data. The result is stored in the memory for error diffusion processing. Once the process is done, one obtains one row of finished halftone pixel data and two rows of error diffused pixel data. The two rows of error diffused pixel data are kept and added with a new row of original pixel data. This diffusion process continues until all pixels in the image data are converted into halftone data.

A conventional means is to store the three rows of pixels in dynamic random access memory (DRAM). Therefore, during the error diffusion process, the system has to continuously read from and write to the DRAM. The efficiency of the DRAM will thus be lowered. Since the pixel being processed and its surrounding pixels have discontinuous addresses in the DRAM, one is not able to utilize the burst mode of the DRAM. On the other hand, storing the three rows of pixel data in the static random access memory (SRAM) in the image processing chip will waste too much of the space.

To solve this problem, the U.S. Pat. No. 6,014,227 proposed a method that associates the number of nozzles with the size of memory to be used in order to effectively manage memory and increase its efficiency. However, the method is limited by the number of nozzles and becomes inflexible. In the U.S. Pat. No. 6,006,011, the whole image is stored in the DRAM and the error diffusion is performed pixel by pixel. However, this method does not only limit the size of the image to be less than the size of the DRAM, it also requires a huge memory space for processing data.

### SUMMARY OF THE INVENTION

In view of the foregoing, the invention provides a memory management method for error diffusion and its halftone processing module. Its does not only reduce the use of required chip internal memory resources, the number of times to access external memory is also reduced.

The disclosed memory management method for error diffusion divides an image to be processed into several small blocks, each of which is smaller than the size of the chip internal memory. Each block is stored in the internal memory and the initial region of the block is filled with the required pixel, so that the pixel in the initial region can be error diffused. The block is processed with error diffusion until the final region, which is reserved to its adjacent block as the filling pixel. This process continues until the whole image is converted into a halftone image.

The halftone processing module according to the disclosed error diffusion method contains an image processing chip, an internal memory, and an external memory. The internal memory is inside the image processing chip, and the external memory is outside the image processing chip. Its divides an image into several blocks smaller than the internal memory in size. The blocks are stored in order in the internal memory for the image processing chip to diffuse errors. The initial region of a block has to be filled with a pixel for diffusing the error of the initial pixel. The pixels in the final region that cannot be error diffused are temporarily stored in the external memory for processing the next adjacent block. This method can not only use the burst mode of the external memory to increase the efficiency, but also effectively makes use of the space in the internal memory and the external memory.

### BRIEF DESCRIPTION OF THE DRAWINGS

The invention will become more fully understood from the detailed description given hereinbelow illustration only, and thus are not limitative of the present invention, and wherein:

FIG. 1A is a schematic view of the conventional 3×5 error diffusion filter;

FIG. 1B is a schematic view of the conventional 2×3 error diffusion filter;

FIG. 2 is a schematic view of dividing an image into several blocks according to the invention;

FIG. 3 is a schematic view of the block error diffusion according to the invention;

FIG. 4 is a schematic view the blocks in a second embodiment of the invention;

FIG. 5 is a schematic view of dividing an image into blocks in the second embodiment of the invention;

FIGS. 6A and 6B are schematic views of pixels that cannot be processed in the blocks;

FIG. 7 is a schematic view of the hardware structure of the invention; and

FIG. 8 is a schematic view of the steps in the disclosed method.

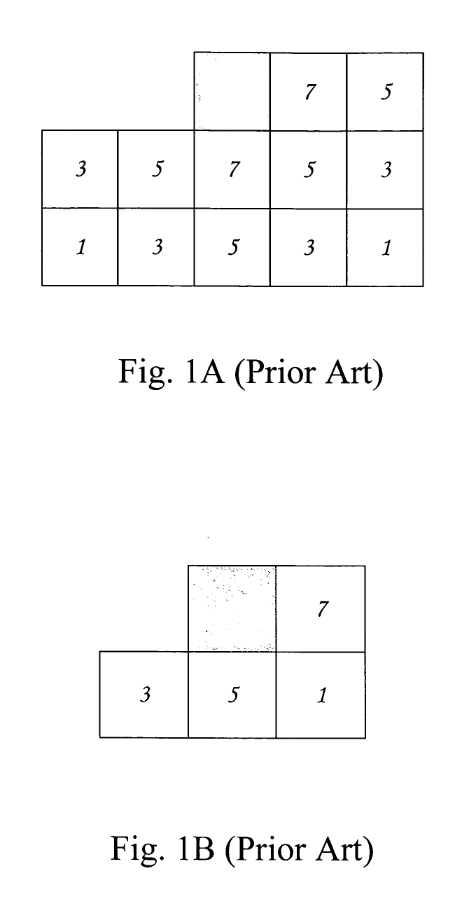

### DETAILED DESCRIPTION OF THE INVENTION

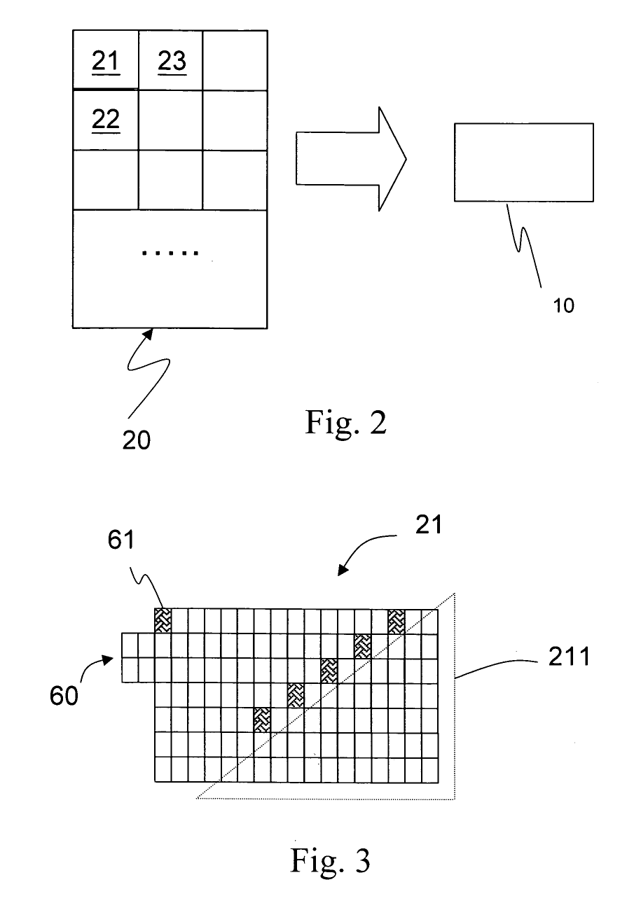

With reference to FIG. 2, the main idea of the invention is to divide an image 20 to be processed into several blocks (the first block 21, the second block 22, and the third block 23 in the drawing). The image is sent block by block to an internal memory 10 of the chip for error diffusion. If the design is such that the image 20 is stored in an external memory (usually DRAM), then the blocks are transmitted using the burst mode in the DRAM special direct memory access (DMA) method. Of course, the disclosed method can also directly access the block data from the image, not through the DRAM. The image 20 can be the whole image or just a part of the whole image. In either case, the image to be processed is first stored in the DRAM and then divided into several blocks for processing.

Since the method processes in blocks, one has to consider the problem of boundary pixels. As shown in FIG. 3, when the first block 21 is error diffused, it starts from the first pixel 61 on the upper right corner. We use the 3×5 error diffusion as an example here (the quantity of pixels shown in the drawing is only representative). Each error diffusion unit 60 has to diffuse the pixel 61 being processed to the right and downward to 12 pixels. However, since this is the first block 21, the initial region of each row has to be filled with an empty pixel. The last two rows of pixels have to be added with the previous row of pixels in the second block, they have to be reserved when processing the first block (to be described later). The columns on the right of the first block 21 also have the similar problem: they have to be processed with the inclusion of the initial regions in the third block 23. Therefore, such pixels are also reserved, leaving an approximately triangular region 211 that cannot be processed.

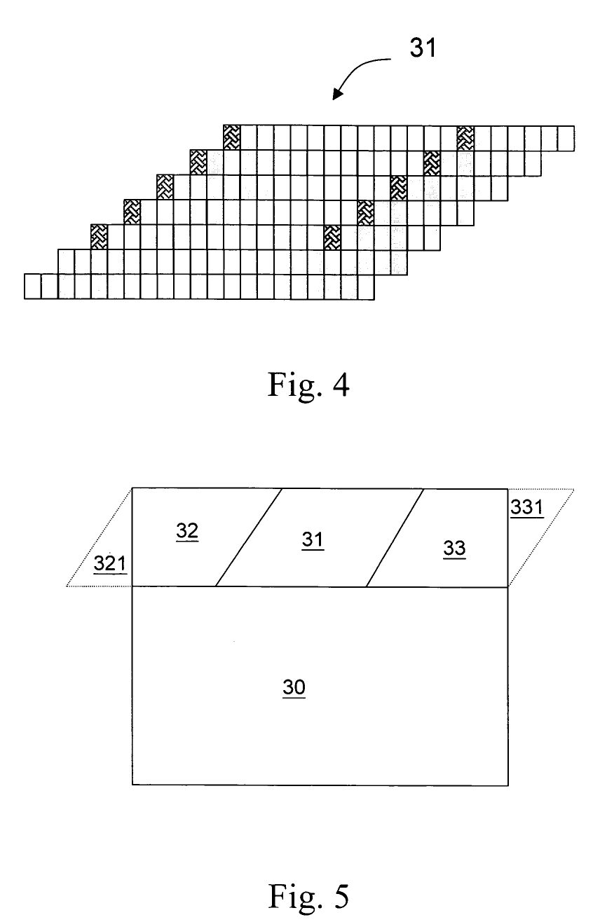

The invention provides a second embodiment in which the blocks are designed to have an approximately zigzag shape. A first block 31 is shown in FIG. 4. The division of the whole image 30 is shown in FIG. 5. As shown in the drawing, the blocks in the first row are the first block 31, the second block 32, and the third block 33. Of course, the method is not limited to three blocks in a row. The division is determined by the size of the image 30 and the capacity of the internal memory 10. We only show the blocks in the first row of the image 30. In order to have a certain regularity and to comply with the error diffusion rules, we find that the initial region of the second block 32 has an initial filling region 321 and the third block 33 in the final region has a final filling region 331. Both regions are comprised of empty pixels. However, if the image 30 being processed is only a part of a whole image, the initial filling region 321 and the final filling region 331 are filled by the adjacent images.

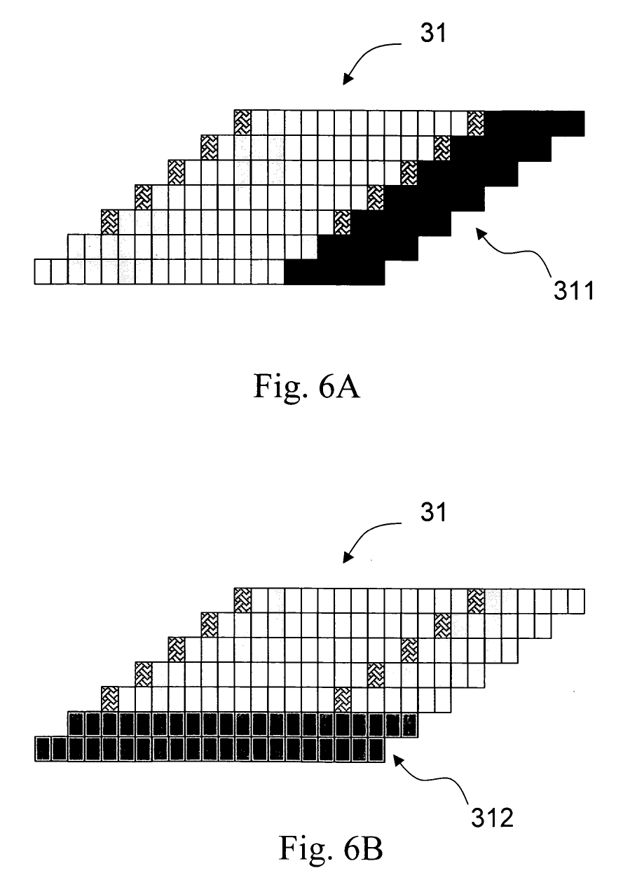

Dividing the image using the above-mentioned rules, the right-hand side of the first block 31 has a region 311 that cannot be processed (see FIG. 6A). There is also a region at the bottom 312 that cannot be processed (see FIG. 6B). (We use the 3×5 case as an example. Using 2×3 or other error matrices will result in different schemes.) The processing schemes for the two regions will differ for different error diffusion methods. The basic scheme for the error diffusion is “to the right and downward,” the right-hand side region 311 that cannot be processed can be directly reserved in the internal memory 10 for filling its adjacent blocks. The bottom region 312 that cannot be processed is stored in the external memory for the adjacent blocks in the next row.

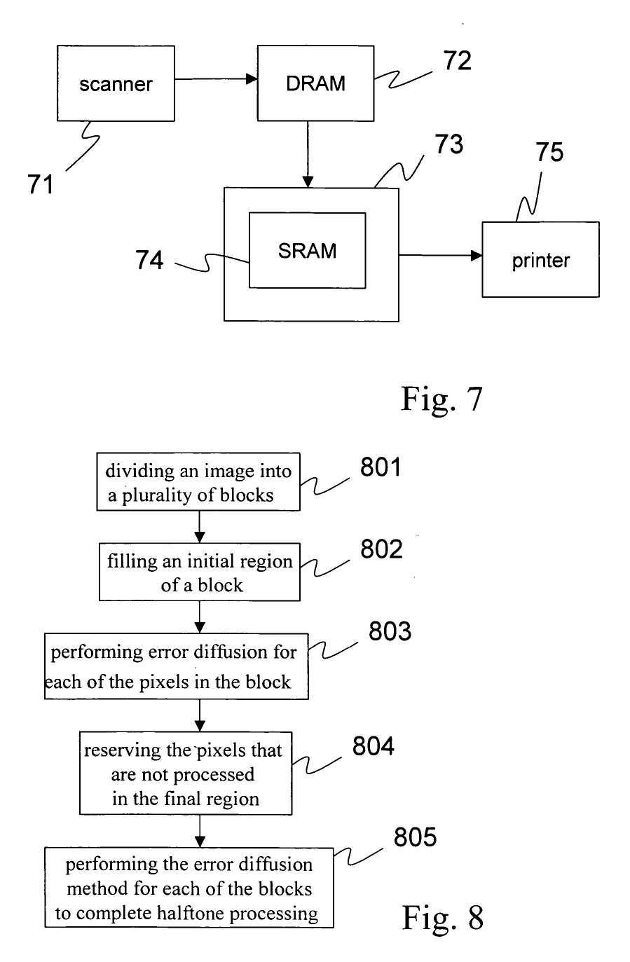

In the following, we use an MFP example to explain the invention. With reference to FIGS. 7 and 8, when using the scanner 71 and printing with the printer 75, the scanned image is first stored in the DRAM 72. The stored image is divided into several blocks (step 801). The shape of such blocks can be geometrical shapes arranged in an array (such as the rectangles in FIG. 2) or the approximate zigzag shape for the error diffusion method (see FIG. 5). Each block is stored in the internal memory (usually SRAM 74). The initial region of the block (including the left-hand side and the top side) is filled with the required pixels according to the error diffusion method (step 802). The filling scheme is described before. For the blocks in the first row, there is no top side to be filled.

The image processing chip 73 performs the error diffusion for the pixels in each block (step 803). The usual method is to diffuse to the right and downward. The block in the final region that cannot be processed is reserved to the adjacent block (step 804). The reservation method of the final region is shown in FIGS. 6A and 6B. The region on the right-hand side 311 that cannot be processed is directly reserved in the SRAM 74. The bottom region 312 that cannot be processed is reserved in the DRAM 72. When processing the adjacent block on the right-hand side, the right-hand-side region 311 that cannot be processed can be directly filled into the initial region on the left-hand side. When processing the adjacent blocks in the next row, the bottom region 312 that cannot be processed can be read and filled into the initial region of the top. Each block is error diffused in order until the halftone process is finished (step 805). Afterwards, the printer 75 outputs the result. The above embodiment is only an example that the scanner 71 obtains the input and the printer 75 output. Other image I/O schemes have the same principles.

Certain variations would be apparent to those skilled in the art, which variations are considered within the spirit and scope of the claimed invention.

1. A memory management method for error diffusion comprising the steps of:
dividing an image to be processed into a plurality of blocks;
filling an initial region of a block according to an error diffusion method;
performing error diffusion in order for each of the pixels in the block;
reserving the pixels that are not processed in the final region of the block to the next adjacent block; and
performing the error diffusion method for each of the blocks to complete halftone processing.

2. The method of claim 1, wherein the size of each divided block is smaller than the size of memory.

3. The method of claim 2, wherein the memory is an internal memory of an image processing chip.

4. The method of claim 3, wherein the internal memory is static random access memory (SRAM).

5. The method of claim 1, wherein the step of dividing an image to be processed into a plurality of blocks divides the image into a plurality of arrayed blocks.

6. The method of claim 5, wherein the arrayed blocks are regular rectangular blocks.

7. The method of claim 1, wherein the step of dividing an image to be processed into a plurality of blocks divides according to the error diffusion method.

8. The method of claim 7, wherein the block is an approximately zigzag shape.

9. The method of claim 1, wherein the step of filling an initial region of a block according to an error diffusion method filling the initial region of the block with required image data so that the pixels in the initial region are to be error diffused.

10. The method of claim 9, wherein the image data being filled are pixels that are not processed in its adjacent blocks.

11. The method of claim 9, wherein the image data being filled are empty pixels.

12. A halftone processing module for error diffusion for dividing an image into a plurality of blocks and using an error diffusion method to perform halftone processing, the module comprising:
an image processing chip, which executes the error diffusion;
an internal memory, which is inside the chip to store the block to be processed and the image data filling in the initial region of the block according to the error diffusion method for the image processing chip to process error diffusions;
and
an external memory, which is outside the chip for providing the internal memory with the pixels needed to fill the block.

13. The halftone processing module of claim 12, wherein the internal memory is static random access memory (SRAM).

14. The halftone processing module of claim 12, wherein the block to be processed has an approximately zigzag shape according to the error diffusion method.

15. The halftone processing module of claim 12, wherein the image data filling in the initial region of the block are the image data that enable all the pixels in the initial region to be error diffused according to the error diffusion method.

16. The halftone processing module of claim 15, wherein the filling image data are the pixels not processed in the adjacent blocks.

17. The halftone processing module of claim 16, wherein the pixels not processed are in the final region of the block.

18. The halftone processing module of claim 15, wherein the filling image data are empty pixels.

19. The halftone processing module of claim 12, wherein the external memory is dynamic random access memory (DRAM).
